(19) United States
(12) Patent Application Publication
(10) Pub. No.: US 2023/0173428 A1
(43) Pub. Date: Jun. 8, 2023

(54) LOW-POWER DIRECT AIR CARBON CAPTURE SYSTEM

(71) Applicant: Varin SIKKA, Los Altos Hills, CA (US)

(72) Inventor: Varin SIKKA, Los Altos Hills, CA (US)

(73) Assignee: Varin SIKKA, Los Altos Hills, CA (US)

(21) Appl. No.: 18/073,426

(22) Filed: Dec. 1, 2022

Related U.S. Application Data
(60) Provisional application No. 63/285,977, filed on Dec. 3, 2021.

(51) Int. Cl. B01D 53/06; F03D 9/00

(52) U.S. Cl. CPC B01D 53/06; F03D 9/00; B01D 2257/504; B01D 2259/4009; F05B 2220/706

(57) ABSTRACT

According to various embodiments, a direct air capture system includes: a wind turbine that includes one or more blades and generates electrical energy when first air flows across the one or more blades; a carbon dioxide (CO₂) adsorption chamber that includes one or more amine-containing CO₂ adsorbers and receives second air when the first air flows across the one or more blades; and a water reservoir that generates steam using a portion of the electrical energy generated by the wind turbine, wherein the water reservoir is fluidly coupled to and isolated from the CO₂ adsorption chamber via one or more valves.

### CROSS-REFERENCE TO RELATED APPLICATIONS

This application claims priority benefit of the United States Provisional Patent Application titled, “TECHNIQUES FOR LOW-POWER, LARGE SCALE DIRECT AIR CAPTURE” filed on Dec. 3, 2021 and having Serial No. 63/285,977. The subject matter of this related application is hereby incorporated herein by reference.

### FIELD OF THE VARIOUS EMBODIMENTS

The various embodiments relate generally to carbon capture technology and, more specifically, to a low-power direct air carbon capture system.

### DESCRIPTION OF THE RELATED ART

According to many scientific studies, global warming is becoming a serious problem for both current and future generations. Many argue that a primary contributor to global warming is the human expansion of the “greenhouse effect,” in which the Earth’s atmosphere traps heat that would otherwise radiate from the Earth into space. The different gases contributing to the greenhouse effect (referred to herein as “greenhouse gases”) include water vapor, methane, nitrous oxide, and carbon dioxide. Many scientists believe that the most serious effects of global warming can be prevented by reducing human-based emissions of greenhouse gases and lowering the concentration of greenhouse gases currently in the Earth’s atmosphere. To that end, one technology being developed to address global warming is direct air carbon capture, where carbon dioxide is captured and removed from the Earth’s atmosphere.

Direct air carbon capture typically involves attempts to remove large quantities of carbon dioxide from the Earth’s atmosphere by an adsorption/desorption process. In many direct air carbon capture implementations, ambient air is exposed to a suitable sorbent, such as an amine-based material, which adsorbs the carbon dioxide present in the ambient air. The adsorbed carbon dioxide is then released from the sorbent via a desorption process for subsequent storage.

For direct air carbon capture or any other process to be a viable approach for reducing the greenhouse effect, the process of removing carbon dioxide from the Earth’s atmosphere needs to result in negative greenhouse gas emissions. That is, the amount of greenhouse gas produced when generating the energy necessary to affect the direct air carbon capture process has to be less than the amount of greenhouse gas the direct air carbon process removes from the Earth’s atmosphere.

One drawback to conventional direct air carbon capture processes is that those processes typically require significant energy, including the thermal energy needed for freeing carbon dioxide in the desorption process and, oftentimes, the fan energy needed for directing ambient air onto the sorbent material. Accordingly, in order to achieve a negative greenhouse gas emission process, direct air carbon capture facilities are typically located at or near large sources of renewable energy, such as the site of a geothermal reservoir, a solar power plant, or a wind farm. Such location constraints prevent conventional direct air carbon capture processes from being broadly implemented, which limits the effectiveness of direct air carbon capture in combating global warming. In addition, direct air carbon capture facilities are normally quite large, having the footprint on the order of a commercial building, which limits where these facilities can be built as well as the number of these facilities that can be built.

As the foregoing illustrates, what is needed in the art are more effective techniques for direct air carbon capture.

### SUMMARY

According to various embodiments, a direct air carbon capture system includes a wind turbine that includes one or more blades and generates electrical energy when first air flows across the one or more blades; a carbon dioxide (CO₂) adsorption chamber that includes one or more amine-containing CO₂ adsorbers and receives second air when the first air flows across the one or more blades; and a water reservoir that generates steam using a portion of the electrical energy generated by the wind turbine, wherein the water reservoir is fluidly coupled to and isolated from the CO₂ adsorption chamber via one or more valves.

At least one technical advantage of the disclosed design relative to the prior art is that the disclosed design enables direct air carbon capture without needing a large, centralized source of renewable energy. In addition, the disclosed design is versatile and can be scaled down to a size suitable for residential applications or up to a size suitable for industrial-level applications. Thus, the disclosed design greatly expands where direct air carbon capture processes can be implemented relative to conventional approaches. Another technical advantage of the disclosed design is that fan energy is not required for direct air carbon capture, which enables the direct air carbon capture process effected by the disclosed design to be greenhouse gas net-negative. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a direct air carbon capture system configured to implement one or more aspects of the various embodiments.

FIG. 2A depicts the direct air carbon capture system of FIG. 1 during an adsorption process, according to various embodiments.

FIG. 2B depicts the direct air carbon capture system of FIG. 1 during a desorption process, according to various embodiments.

FIG. 3 is a more detailed illustration of the direct air carbon capture system of FIG. 1, according to various embodiments.

FIG. 4 is a more detailed illustration of the CO₂ adsorption chamber of FIG. 1, according to various embodiments.

FIG. 5 is a more detailed illustration of the direct air carbon capture system of FIG. 1, according to other various embodiments.

FIG. 6 sets forth a flowchart of method steps for direct air carbon capture, according to various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

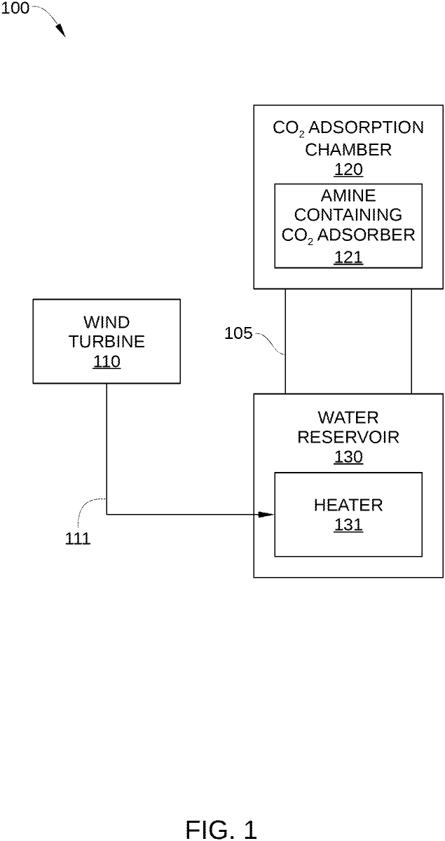

FIG. 1 is a conceptual illustration of a direct air carbon capture system 100 configured to implement one or more aspects of the various embodiments. Direct air carbon capture system 100 removes carbon dioxide (CO₂) from ambient air via a direct air carbon capture process that is powered using electrical energy 111 generated by a wind turbine 110. In some embodiments, little or no fan energy is expended as part of the direct air carbon capture process, thereby increasing the total negative greenhouse gas emissions of the process. As shown, direct air carbon capture system 100 includes a wind turbine 110 that generates electrical energy 111, a CO₂ adsorption chamber 120, and a water reservoir 130 for generating steam via electrical energy 111. CO₂ adsorption chamber 120 can be fluidly coupled to and decoupled from water reservoir 130, for example via one or more valves and/or conduits 105.

Wind turbine 110 includes one or more blades, such as airfoil blades, and generates electrical energy 111 from a flow of ambient air (not shown in FIG. 1) across the one or more blades. Wind turbine 110 can be any technically feasible wind turbine configuration, such as a horizontal axis wind turbine (HAWT) or vertical axis wind turbine (VAWT). For example, in embodiments in which wind turbine 110 is a HAWT, the blades are airfoils that are fitted to a horizontally-oriented rotor. A HAWT enables the positioning of the blades and rotors relatively high off the ground, so that higher and more consistent operational wind speed is received. Consequently, HAWTs are commonly employed in large-scale wind farms. In embodiments in which wind turbine 110 has a VAWT configuration, the rotational axis of the turbine is perpendicular to the ground. Unlike a HAWT, a VAWT can be powered by wind coming from any direction, and therefore has the ability to produce energy efficiently in inconsistent and/or variable wind conditions. Consequently, VAWTs are ideal for installations where wind conditions are not consistent or where the turbine cannot be placed high enough to benefit from steady wind, such as small wind projects and residential applications.

CO₂ adsorption chamber 120 is configured to remove CO₂ from ambient air via an adsorption process and to release the adsorbed CO₂ via a desorption process. To that end, CO₂ adsorption chamber 120 includes one or more amine-containing CO₂ adsorbers 121. In operation, CO₂ adsorption chamber 120 receives a flow of ambient air, and CO₂ present in the ambient air is adsorbed by amine-containing CO₂ adsorbers 121. The adsorbed CO₂ is then released from amine-containing CO₂ adsorbers 121 during a desorption process, in which amine-containing CO₂ adsorbers 121 are heated with steam generated in water reservoir 130. In some embodiments, the released CO₂ is dissolved into the condensed steam (liquid water) that forms on surfaces of amine-containing CO₂ adsorbers 121, and the CO₂-containing liquid water is returned to water reservoir 130. Alternatively or additionally, in some embodiments, released gas-phase CO₂ is flushed into water reservoir 130 by the steam generated in water reservoir 130 and introduced into CO₂ adsorption chamber 120. In either case, during the desorption process, CO₂ disposed within amine-containing CO₂ adsorbers 121 is transported to water reservoir 130 for subsequent separation and/or storage.

Water reservoir 130 is configured to generate steam via electrical energy 111 that is generated by wind turbine 110. Thus, water reservoir 130 is configured to contain liquid water and includes a heater 131 for generating steam from the liquid water. Further, water reservoir 130 is fluidly coupled to and isolated from CO₂ adsorption chamber 120 via one or more valves and conduits (not shown in FIG. 1). In some embodiments, water reservoir 130 is also fluidly coupled to an apparatus (not shown) for sequestration of gas-phase CO₂ and/or separation of gas-phase CO₂ into carbon and oxygen. Alternatively or additionally, in some embodiments, water reservoir 130 is fluidly coupled to a system (not shown) for underground injection of CO₂-containing water, where the CO₂ and is permanently removed from the biosphere via a mineralization process.

Direct air carbon capture system 100 enables the collection of CO₂ from ambient air 201 using locally generated wind power. Thus, any location that has at least some wind power potential can be a suitable location for the construction of direct air carbon capture system 100. Further, the herein described adsorption/desorption process does not rely on large supply fan systems for exposing amine-containing CO₂ adsorbers 121 to ambient air 201. As a result, direct air carbon capture system 100 does not require a large-scale renewable energy source to operate effectively, and therefore can be implemented in residential- or industrial-scale projects.

### Adsorption/Desorption Process

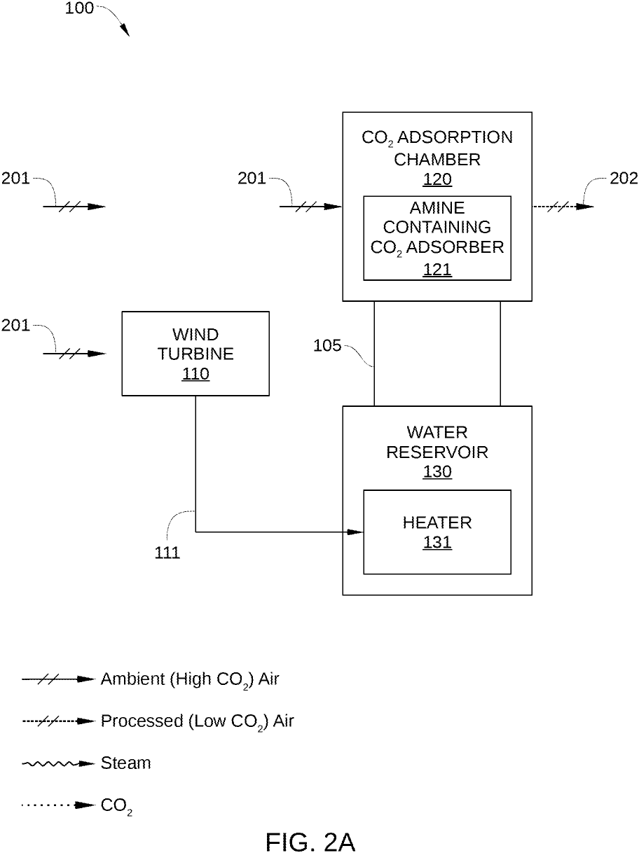

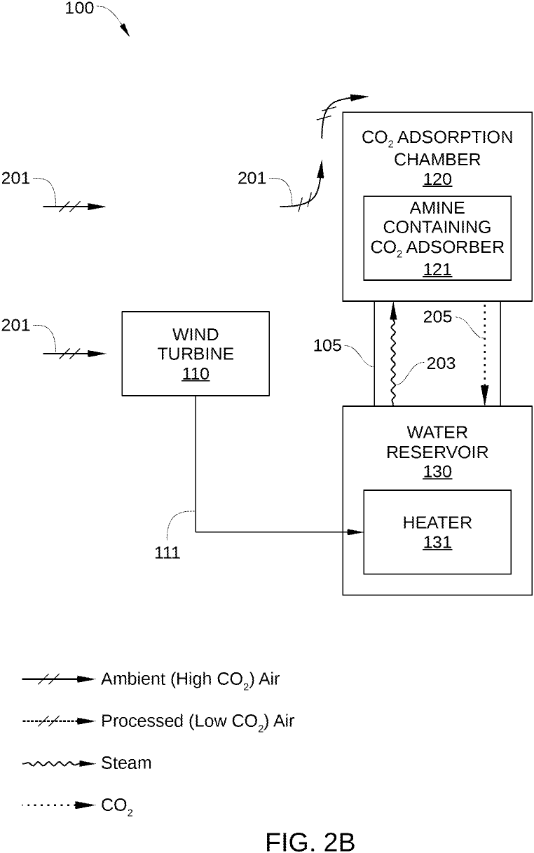

FIG. 2A depicts direct air carbon capture system 100 during an adsorption process, according to various embodiments. As shown, a flow of ambient (high- CO₂) air 201 enables wind turbine 110 to generate electrical energy 111. In addition, a portion of the flow of ambient air 201 enters CO₂ adsorption chamber 120, where CO₂ is captured from ambient air 201 via adsorption by amine-containing CO₂ adsorbers 121. As a result, processed (low- CO₂) air 202 flows out of CO₂ adsorption chamber 120. Further, during the adsorption process, electrical energy 111 generated by wind turbine 110 heats water disposed within water reservoir 130.

FIG. 2B depicts direct air carbon capture system 100 during a desorption process, according to various embodiments. As shown, the flow of ambient air 201 continues to enable wind turbine 110 to generate electrical energy 111. In addition, CO₂ adsorption chamber 120 is closed to the entry of ambient air 201 and the generation of processed air 202. CO₂ adsorption chamber 120 is also fluidly coupled to water reservoir 130, for example via one or more valves and/or conduits 105. Thus, during the desorption process, steam 203 from water reservoir 130 enters or is forced to enter CO₂ adsorption chamber 120, for example via free convection or a fan. As a result, steam 203 heats amine-containing CO₂ adsorbers 121, so that CO₂ 205 is released therefrom. CO₂ 205 is then removed from CO₂ adsorption chamber 120 and transported to water reservoir 130. In some embodiments, CO₂ 205 is transported to water reservoir 130 as gas-phase CO₂ that is flushed from CO₂ adsorption chamber 120 via steam 203. Alternatively or additionally, in some embodiments, CO₂ 205 is transported to water reservoir 130 by being dissolved into the condensed steam (liquid water) that forms on surfaces of amine-containing CO₂ adsorbers 121 as steam 203 heats amine-containing CO₂ adsorbers 121. In such embodiments, the CO₂-containing water is returned to water reservoir 130, for example by draining via gravity.

### First Embodiment

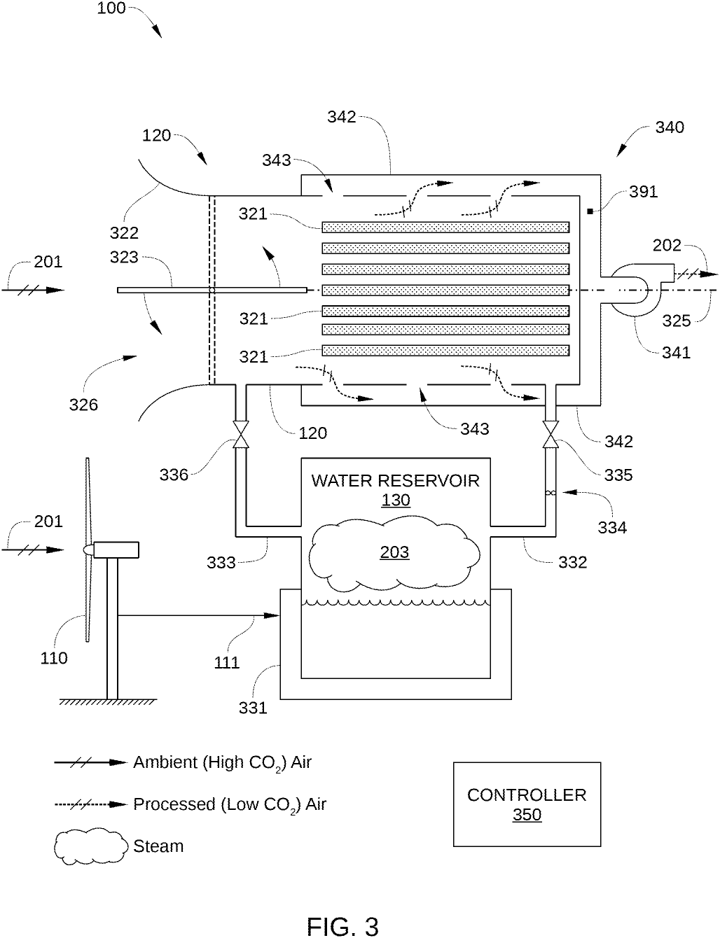

FIG. 3 is a more detailed illustration of direct air carbon capture system 100, according to various embodiments. In the embodiment illustrated in FIG. 3, CO₂ adsorption chamber 120 includes a plurality of amine-containing CO₂ adsorbers 321, an inlet bell 322, an inlet valve 323, an exhaust system 340 and a controller 350. Further, water reservoir 130 includes a heater 331 powered by electrical energy 111 that is generated by wind turbine 110. Water reservoir 130 is fluidly coupled to CO₂ adsorption chamber 120 via one or more conduits and valves, as described below. In FIG. 3, direct air carbon capture system 100 is depicted during an adsoprtion process, in which CO₂ is captured from ambient air 201 via adsorption by amine-containing CO₂ adsorbers 321.

Amine-containing CO₂ adsorbers 321 include a sorbent that is capable of removing CO₂ from ambient air via adsorption, such as an amine-containing material. Any technically feasible amine-containing material can be employed in amine-containing CO₂ adsorbers 321 that can collect CO₂ from ambient air and can release the collected CO₂ via thermal desorption. Thermal desorption is the process by which an adsorbate, such as CO₂ molecules, is heated and thereby desorbed from surfaces of the sorbent. Generally, desorption occurs when a molecule gains sufficient energy to overcome the activation barrier or the bounding energy that keeps the molecule adsorbed to a surface. In some embodiments, amine-containing CO₂ adsorbers 321 are configured as high-surface area components, such as tubes, fins, and the like. In the embodiment illustrated in FIG. 3, amine-containing CO₂ adsorbers 321 are configured as an array of tubes that contain and/or are formed from an amine-based material. In such an embodiment, each of the tubes may be oriented parallel to a longitudinal axis 325 of CO₂ adsorption chamber 120.

Inlet bell 322 is disposed at an inlet opening 326 of CO₂ adsorption chamber 120 and facilitates the capture of ambient air 201 during an adsorption process. Inlet valve 323 is actuated to an open position (as shown) during an adsorption process, and is actuated to a closed position (dashed lines) to seal inlet opening 326 during a desorption process. Exhaust system 340 includes one or more exhaust fans 341 that are fluidly coupled to the inside of CO₂ adsorption chamber 120 via one or more ducts 342 and a plurality of exhaust openings 343. Thus, exhaust system 340 removes processed (low- CO₂) air 202 from CO₂ adsorption chamber 120 during an adsorption process, thereby enabling ambient air 201 to continue to flow into CO₂ adsorption chamber 120 during the adsorption process. In some embodiments, exhaust fan(s) 341 are powered by electrical energy 111 generated by wind turbine 110.

In the embodiment illustrated in FIG. 3, water reservoir 130 is fluidly coupled to CO₂ adsorption chamber 120 via a supply conduit 332 and a return conduit 333 during a thermal desorption process. In such embodiments, supply conduit 332 enables the introduction of steam 203 into CO₂ adsorption chamber 120 during the thermal desorption process, while return conduit 333 enables the transport of CO₂ from CO₂ adsorption chamber 120 to water reservoir 130. For example, in some embodiments, supply conduit 332 has a fan 334 disposed therein that blows or otherwise forces steam 203 from water reservoir 130 into CO₂ adsorption chamber 120 during the thermal desorption process, while during an adsorption process, a valve 335 disposed within supply conduit 332 fluidly isolates supply conduit 332 from CO₂ adsorption chamber 120. Similarly, in such embodiments, return conduit 333 enables the transport of CO₂ from CO₂ adsorption chamber 120 to water reservoir 130 during the thermal desorption process, while during an adsorption process, a valve 336 disposed within return conduit 333 fluidly isolates return conduit 333 from CO₂ adsorption chamber 120. In some embodiments, fan 334 is powered by electrical energy 111 generated by wind turbine 110.

During the thermal desorption process, CO₂ released from amine-containing CO₂ adsorbers 321 is transported to water reservoir 130. In some embodiments, the CO₂ released from amine-containing CO₂ adsorbers 321 can be dissolved into the liquid water that is formed as steam 203 condenses during the desorption process. In such embodiments, the CO₂-containing liquid water can be returned via gravity to water reservoir 130 via return conduit 333. Alternatively or additionally, in some embodiments, the CO₂ released from amine-containing CO₂ adsorbers 321 can be transported to water reservoir 130 via return conduit 333 as gas-phase CO₂. In such embodiments, gas-phase CO₂ that is released from amine-containing CO₂ adsorbers 321 is displaced by the steam 203 being urged into CO₂ adsorption chamber 120 by fan 334 during the thermal desorption process.

Controller 350 is configured to control operation of direct air carbon capture system 100, and may be any technically feasible hardware unit capable of processing data and/or executing instructions associated with the operation of direct air carbon capture system 100. In operation, controller 350 controls operation of inlet valve 323, exhaust fan(s) 341, fan 334, valve 335, valve 336, and heater 331. Specifically, during the adsorption process controller opens inlet valve 323, closes valve 335 and valve 336, and causes exhaust fan(s) 341 to run. During the thermal desorption process, controller 350 closes inlet valve 323, opens valve 335 and valve 336, causes exhaust fan(s) 341 to stop and fan 334 to run. In some embodiments, controller 350 receives inputs from one or more sensors, such as a processed air sensor 391 or other sensor that monitors adsorption and/or desorption processes.

Controller 350 can be implemented as any suitable processor or computing device, such as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU or digital signal processor (DSP). In some embodiments, controller 350 is implemented as a one or more integrated circuits or chips included in direct air carbon capture system 100. Alternatively, in some embodiments, controller 350 is implemented as a computing device, such as a desktop computer, laptop computer, mobile phone, electronic tablet, and/or the like.

### Second Embodiment

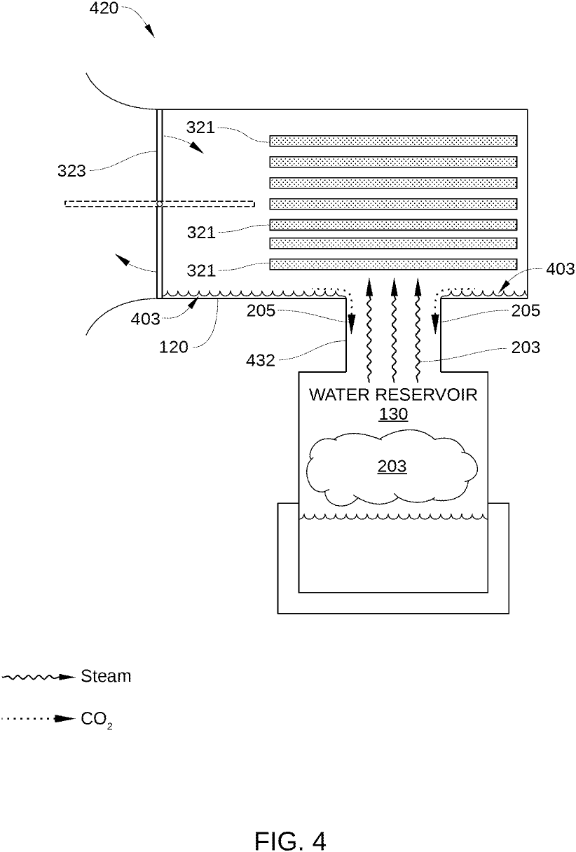

In the embodiment illustrated in FIG. 3, water reservoir 130 is fluidly coupled to CO₂ adsorption chamber 120 via multiple conduits (e.g., supply conduit 332 and return conduit 333) during the thermal desorption process. In other embodiments, water reservoir 130 is fluidly coupled to CO₂ adsorption chamber 120 via a single conduit during the thermal desorption process. One such embodiment is described below in conjunction with FIG. 4.

FIG. 4 is a more detailed illustration of a CO₂ adsorption chamber 420, according to various embodiments. In FIG. 4, CO₂ adsorption chamber 420 is depicted during a thermal desorption process, in which CO₂ is released from amine-containing CO₂ adsorbers 321 via heating by steam 203. For clarity, an exhaust system associated with CO₂ adsorption chamber 420 is omitted in FIG. 4.

In the embodiment illustrated in FIG. 4, CO₂ adsorption chamber 420 is fluidly coupled to water reservoir 130 by a single conduit 432 during the thermal desorption process. Thus, in such embodiments, single conduit 432 acts as a supply conduit for steam 203 to enter CO₂ adsorption chamber 420 and as a return conduit for CO₂ 205 to be transported out of CO₂ adsorption chamber 420. For example, in some embodiments, steam 203 enters CO₂ adsorption chamber 420 via free convection and CO₂ released from amine-containing CO₂ adsorbers 321 is transported out of CO₂ adsorption chamber 420 by being dissolved into water 403, which then drains to water reservoir 130. Water 403 is formed on surfaces of amine-containing CO₂ adsorbers 321 when steam 203 heats amine-containing CO₂ adsorbers 321. In such embodiments, CO₂ released from amine-containing CO₂ adsorbers 321 is dissolved in water 403, which then flows via gravity back to water reservoir 130. In the embodiment illustrated in FIG. 4, a single valve (not shown for clarity) fluidly isolates CO₂ adsorption chamber 420 from water reservoir 130 during an adsorption process.

### Third Embodiment

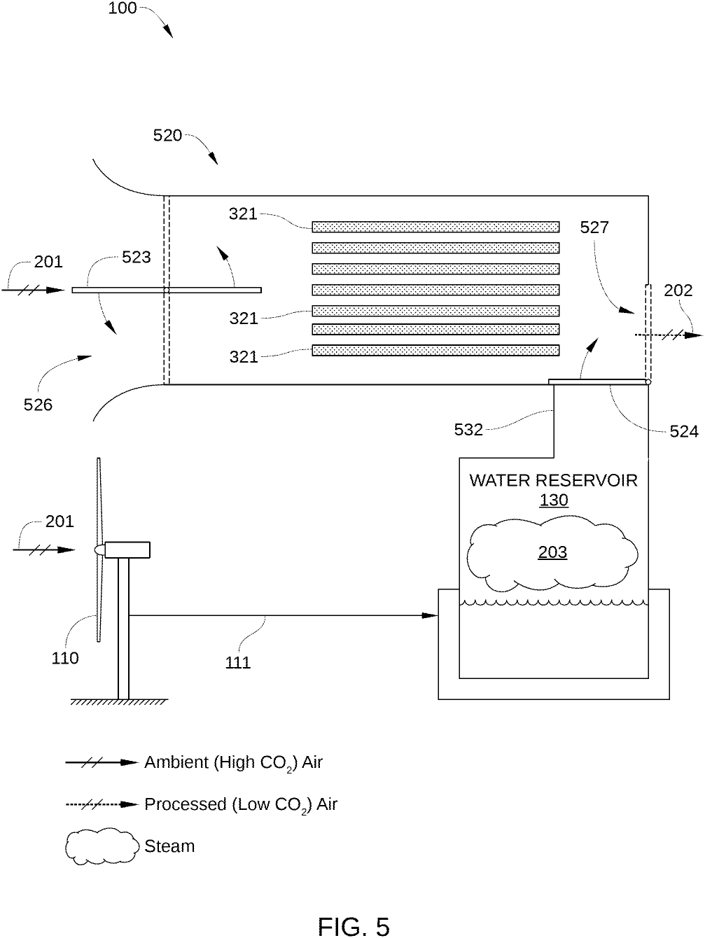

In the above-described embodiments, a continuous flow of ambient air into CO₂ adsorption chamber 120 is maintained during an adsorption process via exhaust system 340. In other embodiments, a continuous flow of ambient air into CO₂ adsorption chamber 120 is maintained during an adsorption process without the expenditure of fan energy. One such embodiment is described below in conjunction with FIG. 5.

FIG. 5 is a more detailed illustration of a direct air carbon capture system 500, according to an embodiment. In the embodiment illustrated in FIG. 5, direct air carbon capture system 500 includes an inlet valve 523 disposed at an inlet opening 526 of a CO₂ adsorption chamber 520 and an outlet valve 524 at an outlet opening 527 of CO₂ adsorption chamber 520. Inlet valve 523 and outlet valve 524 are actuated to an open position (as shown) during an adsorption process, in which ambient air 201 enters CO₂ adsorption chamber 520, CO₂ is collected by amine-containing CO₂ adsorbers 321, and processed air 202 flows out of CO₂ adsorption chamber 520 via outlet opening 527. By contrast, inlet valve 523 and outlet valve 524 are actuated to a closed position (dashed lines) during a thermal desorption process, in which CO₂ is released from amine-containing CO₂ adsorbers 321 and is transported to water reservoir 130. Thus, inlet valve 523 and outlet valve 524 seal CO₂ adsorption chamber 520 during the thermal desorption process.

It is noted that the same flow of ambient air 201 that enables wind turbine 110 to generate electrical energy 111 facilitates a continuous flow of ambient air 201 into CO₂ adsorption chamber 520 during the adsorption process. As a result, no fan energy is required during the adsorption process, increasing the total negative greenhouse gas emissions associated with the operation of direct air carbon capture system 500.

In the embodiment illustrated in FIG. 5, outlet valve 524 is configured to fluidly isolate water reservoir 130 from CO₂ adsorption chamber 520 when outlet opening 527 is opened and processed air 202 can exit CO₂ adsorption chamber 520. In other embodiments, a separate valve from outlet valve 524 fluidly isolates water reservoir 130 from CO₂ adsorption chamber 520 when outlet opening 527 is opened. Further, direct air carbon capture system 500 is depicted with a single conduit 532 fluidly coupling CO₂ adsorption chamber 520 to water reservoir 130. In other embodiments, multiple conduits may fluidly couple CO₂ adsorption chamber 520 to water reservoir 130 in direct air carbon capture system 500.

### Example Embodiment of Adsorption/Desorption Process

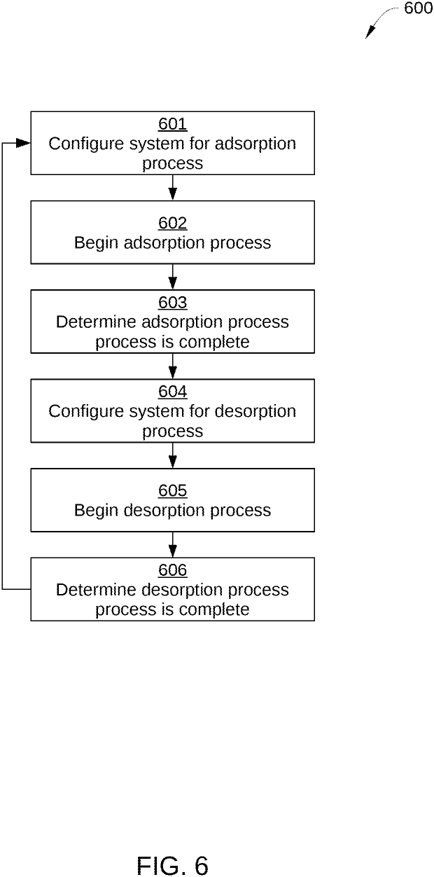

FIG. 6 sets forth a flowchart of method steps for direct air carbon capture, according to various embodiments. Although the method steps are described with respect to laptop computer 200 of FIGS. 1 - 5, any system configured to implement the method steps, in any order, falls within the scope of the various embodiments. Further, although the method steps are illustrated in a particular order, the method steps may be performed in parallel, and/or in a different order than those described herein. Also, the various method steps may be combined into fewer blocks, divided into additional blocks, and/or eliminated based upon a particular implementation.

As shown, a method 600 begins at step 601, where controller 350 configures direct air carbon capture system 100 for an adsorption process. Specifically, controller 350 causes inlet valve 323 to open and enable ambient air 201 to enter CO₂ adsorption chamber 120. In some embodiments, controller 350 also causes one or more exhaust fans 341 to begin running, thereby removing processed air 202 from CO₂ adsorption chamber 120. In other embodiments, controller 350 causes outlet valve 524 to open, so that processed air 202 can passively flow out of CO₂ adsorption chamber 120.

In step 602, an adsorption process begins as ambient air 201 flows into CO₂ adsorption chamber 120 and CO₂ is collected by amine-containing CO₂ adsorbers 121. During the adsorption process, processed air 202 is removed from and/or flows from CO₂ adsorption chamber 120 as ambient air 201 flows into CO₂ adsorption chamber 120.

In step 603, controller 350 determines that the adsorption process is complete. In some embodiments, controller 350 makes such a determination based on a sensor input. In such embodiments, controller 350 may receive an input from processed air sensor 391 indicating that a CO₂ concentration of processed air 202 has exceeded a threshold value. Additionally or alternatively, in some embodiments, controller 350 makes such a determination based on a duration of the adsorption process. Additionally or alternatively, in some embodiments, controller 350 makes such a determination based on an estimated quantity of ambient air that has been processed.

In step 604, controller 350 configures direct air carbon capture system 100 for a desorption process. Specifically, controller 350 causes inlet valve 323 to close and fluidly isolating CO₂ adsorption chamber 120 from ambient air 201. In addition, controller 350 causes CO₂ adsorption chamber 120 to be fluidly coupled to water reservoir 130, for example by opening valve 335 and valve 336, and by causing fan 334 to begin running. Alternatively, in some embodiments, controller 350 causes a single valve to fluidly couple CO₂ adsorption chamber 120 to water reservoir 130, for example outlet valve 524.

In step 605, a desorption process begins as steam 203 flows into CO₂ adsorption chamber 120, and CO₂ that is adsorbed by amine-containing CO₂ adsorbers 121 is released. Steam 203 heats amine-containing CO₂ adsorbers 121 to a temperature sufficient for desorption of adsorbed CO₂ therefrom. For example, in some embodiments, in the desorption process, amine-containing CO₂ adsorbers 121 are heated to a temperature of about 100 C, a temperature at which CO₂ molecules gain sufficient energy to overcome the activation barrier or the bounding energy that keeps the CO₂ molecules adsorbed to surfaces of amine-containing CO₂ adsorbers 121. During the desorption process, CO₂ 205 is transported from CO₂ adsorption chamber 120 to water reservoir 130 for subsequent storage.

In step 606, controller 350 determines that the desorption process is complete. In some embodiments, controller 350 makes such a determination based on a sensor input. Additionally or alternatively, in some embodiments, controller 350 makes such a determination based on a duration of the desorption process.

In sum, the various embodiments shown and provided herein set forth techniques for a low-energy direct air carbon capture process that is powered using electrical energy generated by a wind turbine. Specifically, a flow of ambient air enables the wind turbine to generate electrical power while amine-containing CO₂ adsorbers collect CO₂ from the ambient air via an adsorption process. The electrical power generates steam that is then employed to heat the amine-containing CO₂ adsorbers in a thermal desorption process that releases adsorbed CO₂ from the amine-containing CO₂ adsorbers.

At least one technical advantage of the disclosed design relative to the prior art is that the disclosed design enables direct air carbon capture without the need of a large, centralized source of renewable energy. In addition, the disclosed design can be scaled down to a size suitable for residential applications or up to a size suitable for industrial-level applications. Thus, the disclosed design greatly expands where direct air carbon capture facilities can be operated. A further advantage of the disclosed design is that the expenditure of fan energy is not required for a direct air carbon capture process, thereby increasing the total negative greenhouse gas emissions of the process. These technical advantages provide one or more technological advancements over prior art approaches.

1. In some embodiments, a direct air carbon capture system includes: a wind turbine that includes one or more blades and generates electrical energy when first air flows across the one or more blades; a carbon dioxide (CO2) adsorption chamber that includes one or more amine-containing CO2 adsorbers and receives second air when the first air flows across the one or more blades; and a water reservoir that generates steam using a portion of the electrical energy generated by the wind turbine, wherein the water reservoir is fluidly coupled to and isolated from the CO2 adsorption chamber via one or more valves.

2. The direct air carbon capture system of clause 1, further comprising a return conduit that fluidly couples the water reservoir to the CO2 adsorption chamber.

3. The direct air carbon capture system of clauses 1 or 2, further comprising a controller that causes a first valve that is included in the one or more valves and is disposed within the return conduit to close during an adsorption phase.

4. The direct air carbon capture system of any of clauses 1-3, further comprising a supply conduit that fluidly couples the water reservoir to the CO2 adsorption chamber.

5. The direct air carbon capture system of any of clauses 1-4, further comprising a controller that causes a first valve that is included in the one or more valves and is disposed within the supply conduit to close during an adsorption phase.

6. The direct air carbon capture system of any of clauses 1-5, wherein a first valve included in the one or more valves selectively closes the supply conduit and opens an outlet of the CO2 adsorption chamber.

7. The direct air carbon capture system of any of clauses 1-6, further comprising a fan that is disposed within the supply conduit and blows steam from the water reservoir to the CO2 adsorption chamber.

8. The direct air carbon capture system of any of clauses 1-7, wherein the fan is powered by another portion of the electrical energy generated by wind turbine.

9. The direct air carbon capture system of any of clauses 1-8, further comprising a controller that causes a valve disposed proximate to an inlet of the CO2 adsorption chamber to open during an adsorption process and close during a desorption process.

10. The direct air carbon capture system of any of clauses 1-9, wherein the one or more amine-containing CO2 adsorbers comprise an array of amine-containing tubes.

11. The direct air carbon capture system of any of clauses 1-10, wherein the amine-containing tubes are oriented substantially parallel to a longitudinal axis of the CO2 adsorption chamber.

12. The direct air carbon capture system of any of clauses 1-11, wherein the CO2 adsorption chamber includes exhaust openings that are fluidly coupled to an exhaust fan system.

13. The direct air carbon capture system of any of clauses 1-12, wherein the exhaust fan system is powered by another portion of the electrical energy generated by the wind turbine.

14. In some embodiments, a method includes: adsorbing carbon dioxide (CO2) from a first portion of a flow of ambient air via a CO2 adsorption chamber that includes one or more amine-containing CO2 adsorbers; while adsorbing the CO2, generating electrical energy from a second portion of the flow of ambient air via a wind turbine; generating steam in a water reservoir using a portion of the electrical energy; and heating the one or more amine-containing CO2 adsorbers with the steam.

15. The method of clause 14, wherein heating the one or more amine-containing CO2 adsorbers with the steam comprises fluidly coupling the CO2 adsorption chamber to the water reservoir.

16. The method of clauses 14 or 15, further comprising blowing the steam into the CO2 adsorption chamber with a fan.

17. The method of any of clauses 14-16, wherein the steam enters the CO2 adsorption chamber via fee convection.

18. The method of any of clauses 14-17, further comprising, prior to adsorbing the CO2 from the first portion of the flow of ambient air, fluidly decoupling the CO2 adsorption chamber from the water reservoir.

19. The method of any of clauses 14-18, further comprising, prior to adsorbing the CO2 from the first portion of the flow of ambient air, fluidly coupling the CO2 adsorption chamber to an exhaust fan system.

20. The method of any of clauses 14-19, further comprising, prior to heating the one or more amine-containing CO2 adsorbers with the steam, fluidly decoupling the CO2 adsorption chamber from the flow of ambient air.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

While the preceding is directed to embodiments of the present disclosure, other and further embodiments of the disclosure may be devised without departing from the basic scope thereof, and the scope thereof is determined by the claims that follow.

What is claimed is:

1. A direct air carbon capture system, comprising:
a wind turbine that includes one or more blades and generates electrical energy when first air flows across the one or more blades;
a carbon dioxide (CO₂) adsorption chamber that includes one or more amine-containing CO₂ adsorbers and receives second air when the first air flows across the one or more blades; and
a water reservoir that generates steam using a portion of the electrical energy generated by the wind turbine, wherein the water reservoir is fluidly coupled to and isolated from the CO₂ adsorption chamber via one or more valves.

2. The direct air carbon capture system of claim 1, further comprising a return conduit that fluidly couples the water reservoir to the CO₂ adsorption chamber.

3. The direct air carbon capture system of claim 2, further comprising a controller that causes a first valve that is included in the one or more valves and is disposed within the return conduit to close during an adsorption phase.

4. The direct air carbon capture system of claim 1, further comprising a supply conduit that fluidly couples the water reservoir to the CO₂ adsorption chamber.

5. The direct air carbon capture system of claim 4, further comprising a controller that causes a first valve that is included in the one or more valves and is disposed within the supply conduit to close during an adsorption phase.

6. The direct air carbon capture system of claim 4, wherein a first valve included in the one or more valves selectively closes the supply conduit and opens an outlet of the CO₂ adsorption chamber.

7. The direct air carbon capture system of claim 4, further comprising a fan that is disposed within the supply conduit and blows steam from the water reservoir to the CO₂ adsorption chamber.

8. The direct air carbon capture system of claim 7, wherein the fan is powered by another portion of the electrical energy generated by wind turbine.

9. The direct air carbon capture system of claim 1, further comprising a controller that causes a valve disposed proximate to an inlet of the CO₂ adsorption chamber to open during an adsorption process and close during a desorption process.

10. The direct air carbon capture system of claim 1, wherein the one or more amine-containing CO₂ adsorbers comprise an array of amine-containing tubes.

11. The direct air carbon capture system of claim 10, wherein the amine-containing tubes are oriented substantially parallel to a longitudinal axis of the CO₂ adsorption chamber.

12. The direct air carbon capture system of claim 1, wherein the CO₂ adsorption chamber includes exhaust openings that are fluidly coupled to an exhaust fan system.

13. The direct air carbon capture system of claim 12, wherein the exhaust fan system is powered by another portion of the electrical energy generated by the wind turbine.

14. A method, comprising:
adsorbing carbon dioxide (CO₂) from a first portion of a flow of ambient air via a CO₂ adsorption chamber that includes one or more amine-containing CO₂ adsorbers;
while adsorbing the CO₂, generating electrical energy from a second portion of the flow of ambient air via a wind turbine;
generating steam in a water reservoir using a portion of the electrical energy; and
heating the one or more amine-containing CO₂ adsorbers with the steam.

15. The method of claim 14, wherein heating the one or more amine-containing CO₂ adsorbers with the steam comprises fluidly coupling the CO₂ adsorption chamber to the water reservoir.

16. The method of claim 15, further comprising blowing the steam into the CO₂ adsorption chamber with a fan.

17. The method of claim 15, wherein the steam enters the CO₂ adsorption chamber via fee convection.

18. The method of claim 14, further comprising, prior to adsorbing the CO₂ from the first portion of the flow of ambient air, fluidly decoupling the CO₂ adsorption chamber from the water reservoir.

19. The method of claim 14, further comprising, prior to adsorbing the CO₂ from the first portion of the flow of ambient air, fluidly coupling the CO₂ adsorption chamber to an exhaust fan system.

20. The method of claim 14, further comprising, prior to heating the one or more amine-containing CO₂ adsorbers with the steam, fluidly decoupling the CO₂ adsorption chamber from the a flow of ambient air.
